(19) United States
(12) Patent Application Publication
(10) Pub. No.: US 2009/0062094 A1
(43) Pub. Date: Mar. 5, 2009

(54) CREASING/SLOTTING DEVICE

(76) Inventors: Hirohisa Inoue, Hyogo (JP); Yukihiro Noto, Hyogo (JP); Junjiro Watanabe, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 11/912,405

(22) PCT Filed: Apr. 20, 2006
(86) PCT No.: PCT/JP2006/308290

§ 371 Date: Oct. 24, 2007

(30) Foreign Application Priority Data
May 10, 2005 (JP) 2005 137431

(51) Int. Cl. B31B 1/25

(52) U.S. Cl. 493/60

(57) ABSTRACT

A creasing/slotting device is provided which makes it possible to form slots at ends of creases with the axes of the slots aligned with the respective creases.

A plurality of pairs of upper movable frames 6and lower movable frames 7are arranged perpendicularly to the sheet feed direction. An upper feed screw mechanism 10having a threaded shaft 11for individually moving each of the upper movable frames 6, a lower feed screw mechanism 14having a threaded shaft 15for individually moving each of the lower movable frames 7are provided, and a synchronizing mechanism 20is provided between the threaded shaft 11and 15to synchronize the rotations of the threaded shafts. A pair of creasing rolls 51and 52for forming creases are supported by each vertically opposed pair of the movable frames 6and 7, respectively. Downstream of the pair of the creasing rolls 51and 52, a pair of rotary cutters 71and 72are supported by the pair of movable frames 6and 7. By synchronously rotating the threaded shafts 11and 15, the pair of movable frames 6and 7are moved simultaneously in the same direction by the same distance, so that it is possible to position the pair of creasing rolls 51and 52and the pair of rotary cutters 71and 72without changing the relative position therebetween. This prevents misalignment between the axes of the slots and the respective creases.

### TECHNICAL FIELD

This invention relates to a creasing/slotting device for providing sheets such as corrugated fiberboards and cardboards fed in one direction with creases along which the sheets are to be folded, and slots at both ends of each crease for forming flaps.

### BACKGROUND ART

FIG. 11(II) shows a blank S₁ to be formed into a corrugated fiberboard box. The blank S₁ is formed from a corrugated sheet S₀ shown in FIG. 11(I). The corrugated sheet S₀ is formed beforehand with two parallel transverse creases a₁ and a₂.

In forming the blank S₁, a creasing/slotting device is used. As disclosed in Patent document 1, the creasing/slotting device includes a creasing unit and a slotting unit provided downstream of the creasing unit.

The creasing unit includes two rotary shafts arranged one above the other parallel to each other in the sheet feed path, a plurality of male creasing rolls mounted on the lower rotary shaft, and as many female creasing rolls as the male creasing rolls mounted on the outer periphery of the upper rotary shaft, the female creasing rolls being each corresponding to one of the male creasing rolls. By pressing ribs formed on the outer periphery of the male creasing rolls against a corrugated sheet S₀ being fed between the male creasing rolls and the female creasing rolls, first to fourth longitudinal creases b₁ to b₄ are formed in the sheet.

The slotting unit includes two rotary shafts arranged one above the other parallel to each other in the sheet feed path, a plurality of male rotary cutters each having two slot blades and mounted on the upper rotary shaft, and a plurality of female rotary cutters mounted on the lower rotary shaft and formed in their outer periphery with an annular groove to receive the slot blades. When the slot blades of the male rotary shafts fit in the annular grooves of the respective female rotary cutters, slots c are formed at both ends of each longitudinal creases b₁ to b₄ in the corrugated sheet S₀ being fed between the male and female rotary cutters as shown in FIG. 11(II).

By forming the slots c, four lid flaps F₁ to F₄ and four bottom flaps F₅ to F₈ are defined.

The slotting unit includes a corner cutter for cutting corners on one side of the corrugated sheet S₀, thereby defining a bonding portion d.

After forming the creases and slots, the blank S₁ is fed to a folder, where panels P₁ and P₄ on both sides are folded by 180 degrees along the first and third longitudinal creases b₁ and b₃, and the panel P₁ is bonded to the bonding portion d continuous to the other panel P₄ by a adhesive applied beforehand, so that a flat box is formed.

The size of the box is variable, and with the size of the box, the distances between the longitudinal creases b₁ to b₄ and the distances between the slots c vary. Therefore, with a creasing/slotting device, the male creasing rolls and the female creasing rolls of the creasing unit and the male rotary cutters and the female rotary cutters of the slotting unit are provided so as to be positionable in the axial direction of the rotary shafts. They are axially positioned according to the size of the blank to be formed.

With the creasing/slotting device disclosed in Patent document 1, for the positioning of each pair of male and female creasing rolls, a driving plate is provided for each of the male and female creasing rolls, an opposed pair of coupling plates fixed to each driving plate have their tips inserted in annular grooves formed in the corresponding male and female creasing rolls, a tubular threaded member is threadedly engaged in a screw hole formed in each coupling plate at its tip, slide guide members mounted at both ends of the threaded member have their surfaces in contact with opposite side walls of the annular groove, and the driving plates carrying the slide guide members are moved axially of the rotary shaft as the threaded shaft rotates, thereby positioning the male creasing rolls and the female creasing rolls.

On the other hand, for positioning between each pair of male and female rotary cutters, too, a positioning mechanism of the same structure as the positioning mechanism for the male and female creasing rolls is used.

### Patent Document 1: JP Patent Publication No. 2537336B

### DISCLOSURE OF INVENTION

### Object of the Invention

With the creasing/slotting device disclosed in Patent document 1, since in creasing and slotting of corrugated sheets S₀, the side walls of each annular groove of the male rotary cutter and the female rotary cutter rotate in contact with the surface of the slide guide member, wear of the contact points is unavoidable. If a gap is formed between the side walls of the annular groove and the slide guide member due to such wear, it is not possible to adjust the position of the male creasing rolls and the female creasing rolls and that of the male rotary cutters and the female rotary cutters along the rotary shafts with high accuracy. This can cause misalignment between the longitudinal creases b1 to b3 formed by the male creasing rolls and the female creasing rolls and the slots c formed by the male rotary cutters and the female rotary cutters in a width direction.

Also, with the creasing/slotting device, because the position adjustment of the male creasing rolls and the female creasing rolls and that of the male rotary cutters and the female rotary cutters are separately carried out, subtle differences in the amounts of adjustment may arise, so that some misalignment between the scores b₁ to b₃ and the slots c may occur.

If such misalignment occurs between the creases and the slots, when a packaging box is formed by forming a flat box blank from the blank S₁, erecting the flat box into a rectangular tube and folding lid flaps F₁ to F₄ and bottom flaps F₅ to F₈ inward by 90 degrees into a box shape, the edges of the opposite lid flaps F₁, F₃ may be misaligned as shown in FIG. 12, so that defective boxes are produced. Similar misalignment can occur with bottom flaps F₅, F₇, too.

An object of this invention is to provide a creasing/slotting device which makes it possible to form slots at ends of longitudinal creases with the creases accurately aligned with the axes of the respective slots.

### Means for Achieving the Object

To achieve this object, the present invention provides a creasing/slotting device comprising a plurality of vertically opposed pairs of upper and lower movable frames arranged perpendicularly to a sheet feed direction, upper feed screw mechanisms each having a threaded shaft and capable of individually positioning the upper movable frames in a direction perpendicular to the sheet feed direction by turning the threaded shafts of the respective upper feed screw mechanisms, lower feed screw mechanisms each having a threaded shaft and capable of individually positioning the lower movable frames in a direction perpendicular to the sheet feed direction by turning the threaded shafts of the respective lower feed screw mechanisms, synchronizing mechanisms each provided between the two threaded shafts of the pair of upper and lower feed screw mechanisms for positioning one of the plurality of vertically opposed pairs of upper and lower movable frames, respectively, for synchronizing the rotations of the two threaded shafts, a plurality pairs of male creasing rolls and receiving rolls for forming creases in a sheet, one and the other of each pair of the male creasing rolls and receiving rolls being supported on one and the other of a vertically opposed pair of the upper and lower movable frames, respectively, and a plurality pairs of rotary cutters for forming slots at ends of creases formed in the sheet, one and the other of each pair of the rotary cutters being supported on one and the other of a vertically opposed pair of the upper and lower movable frames, respectively.

### Effects of Invention

As described above, according to this invention, one of each pair of the male creasing rolls and the female creasing rolls and one of two rotary cutters for forming slots are supported on one of the upper and lower movable frames, and the other of the male creasing roll and the female creasing roll and the other of the two rotary cutters are supported on the other of the upper and lower movable frames, and the threaded shaft for the upper feed screw mechanism for positioning each upper movable frame and the threaded shaft for the lower feed screw mechanism for positioning each lower movable frame are controlled by a synchronizing mechanism so as to rotate synchronously. With this arrangement, by rotating the threaded shaft of one of the upper and lower feed screw mechanisms, the upper movable frame and the lower movable frame can be moved by the same distance in the same direction. This makes it possible to adjust the position of each pair of creasing rolls and that of the corresponding pair of rotary cutters for forming slots while keeping relative positional relationship, and thereby to form a slot at least at one end of each longitudinal crease with the axis of the slot in alignment with the crease.

### BRIEF DESCRIPTION OF THE DRAWINGS

FIG. 1 Front view of the creasing/slotting device embodying this invention.

FIG. 2 Sectional view taken along line II-II of FIG. 1

FIG. 3 Enlarged sectional view of the left side portion of FIG. 2

FIG. 4 Sectional view taken along line IV-IV of FIG. 1

FIG. 5 Sectional view taken along line V-V of FIG. 1

FIG. 6 Vertical sectional front view of the creasing/slotting device shown in FIG. 1

FIG. 7 Enlarged sectional view of the creasing unit shown in FIG. 6

FIG. 8 Sectional view taken along line VIII-VIII of FIG. 7

FIG. 9 Sectional view taken along line IX-IX of FIG. 7

FIG. 10 Sectional view taken along line X-X of FIG. 9

FIG. 11 (I) Front view of a corrugated sheet, (II) Front view of a blank made from the corrugated sheet

FIG. 12 Perspective view of a packing box

### DESCRIPTION OF THE REFERENCE NUMBERS

6 Upper movable frame

7 Lower movable frame

10 Upper feed screw mechanism

11 Threaded shaft

14 Lower feed screw mechanism

15 Threaded shaft

20 Synchronizing mechanism

51 Female creasing roll (receiving roll)

52 Male creasing roll

71 Upper rotary cutter

72 Lower rotary receiving blade

### BEST MODE FOR EMBODYING THE INVENTION

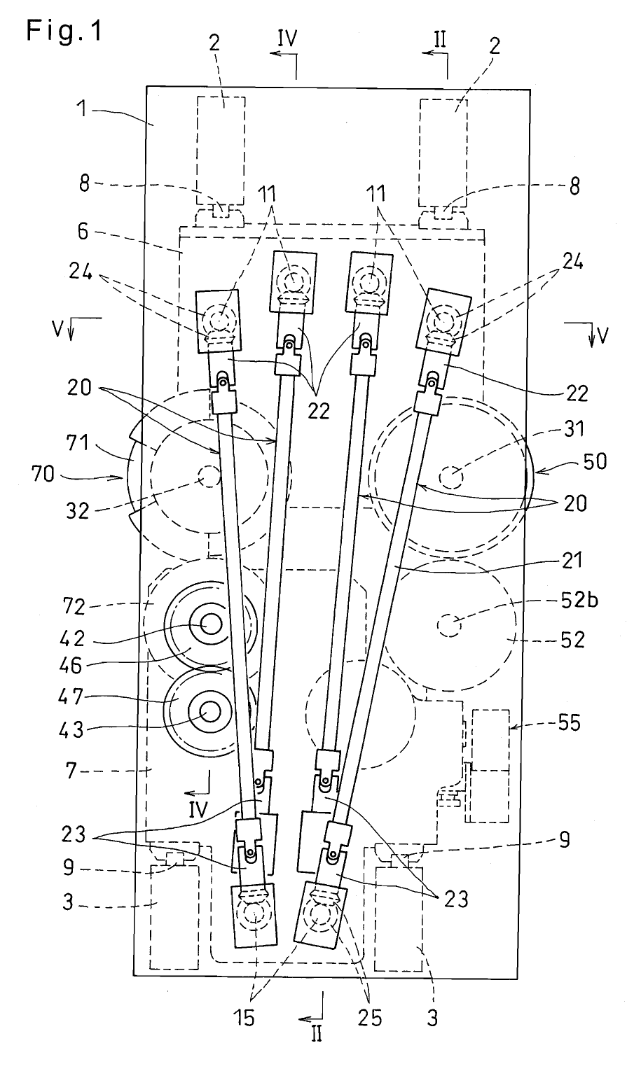

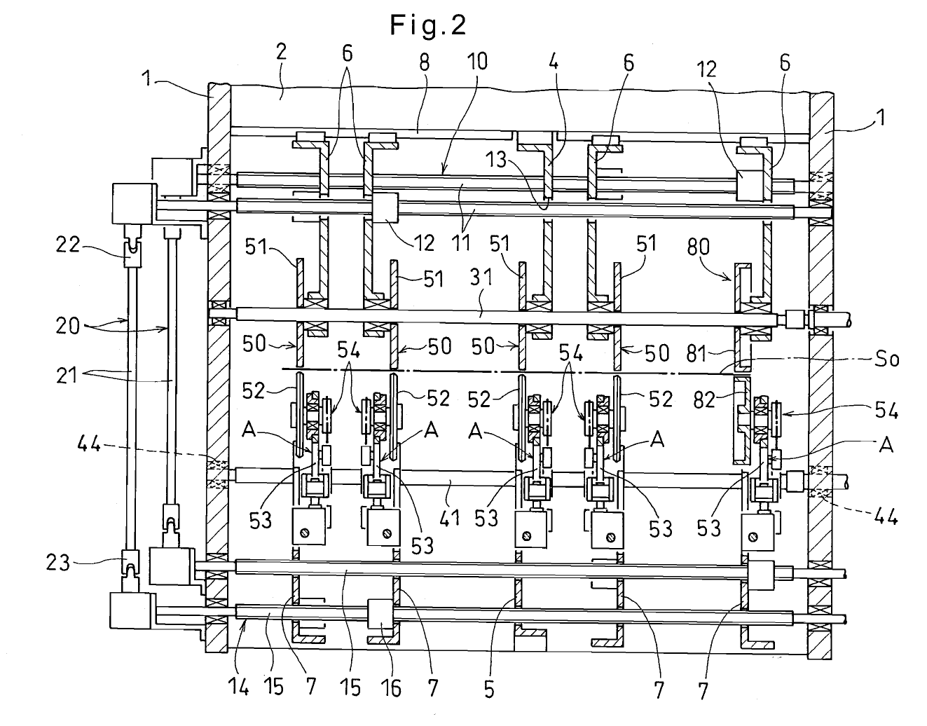

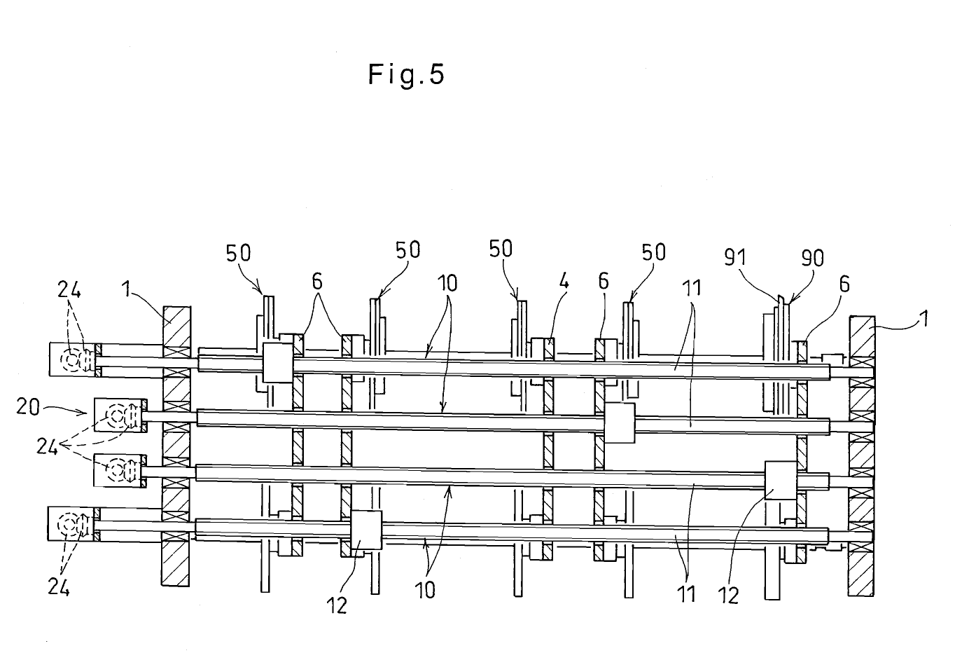

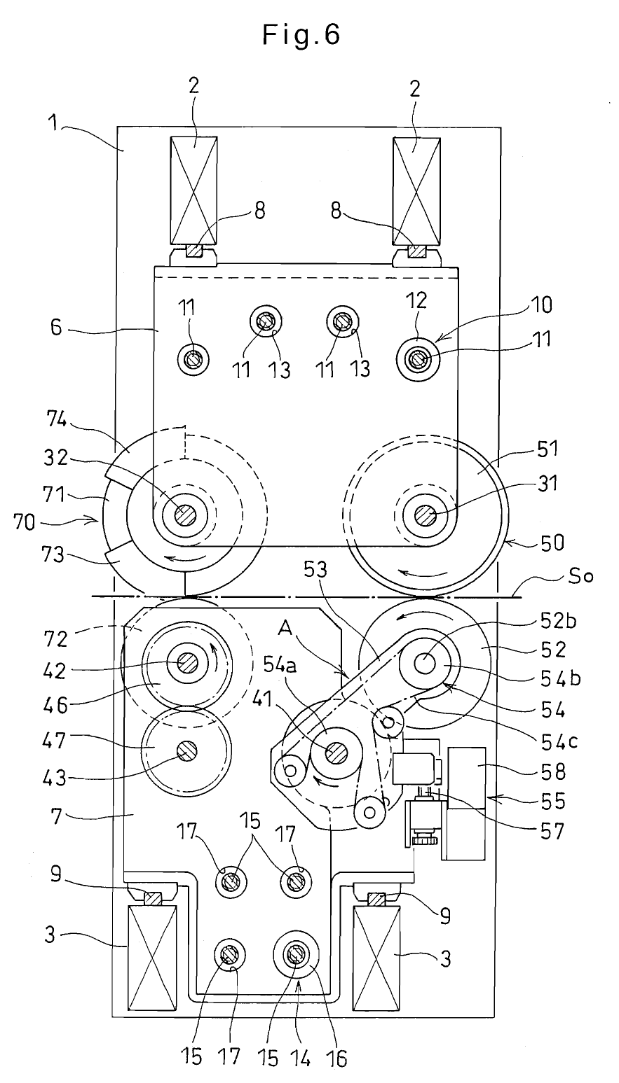

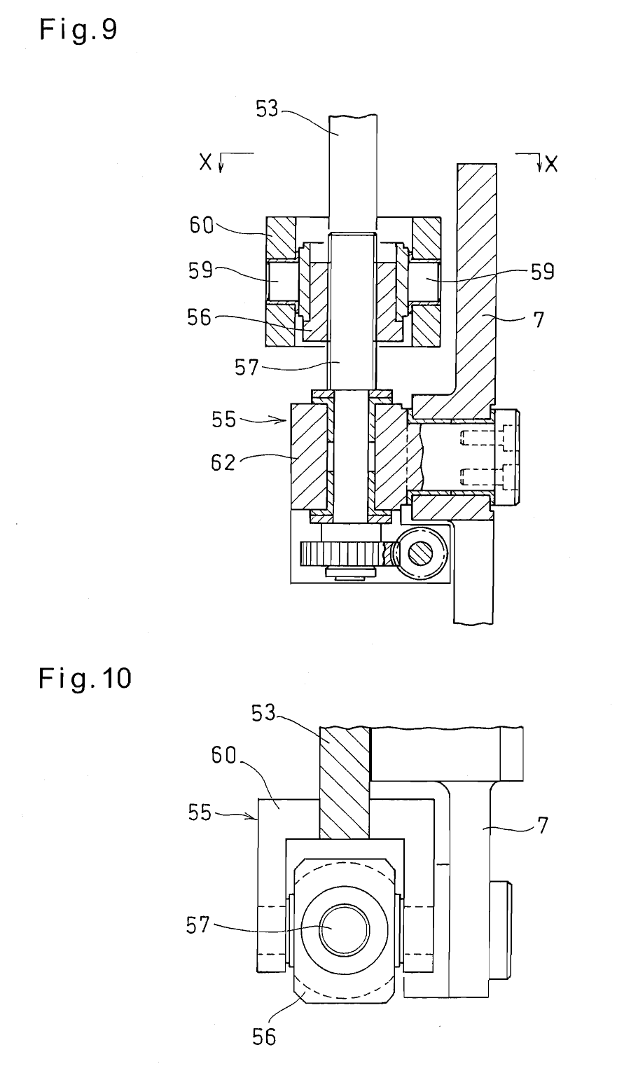

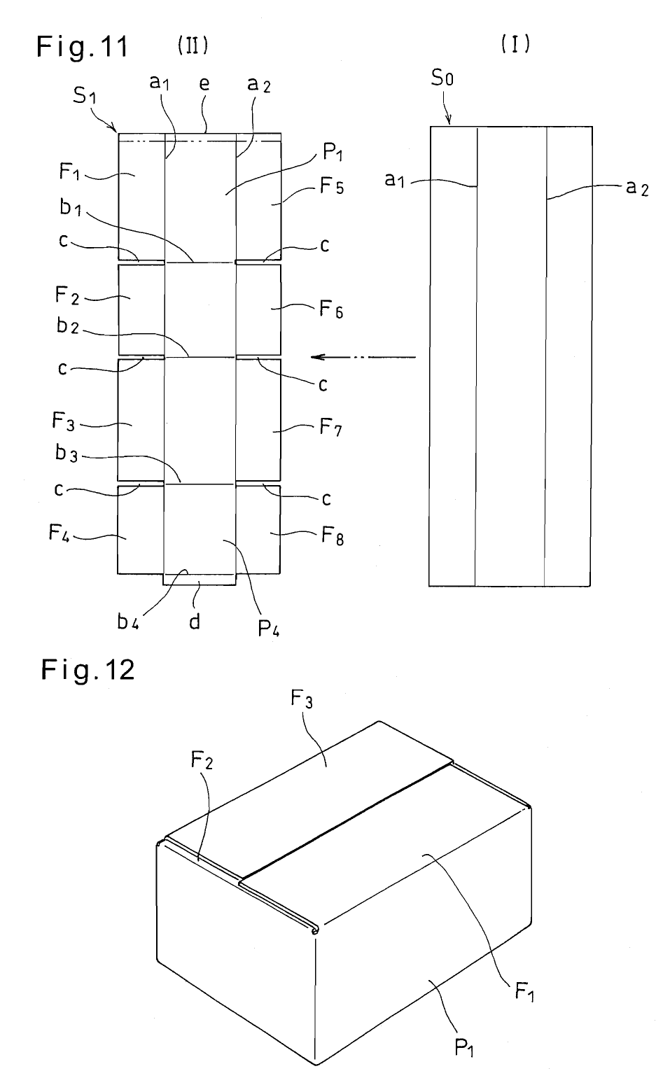

Now the embodiment of this invention is described with reference to the drawings. FIGS. 1 to 10 show a creasing/slotting device for forming creases and slots in a corrugated sheet S₀. As shown in FIGS. 2 and 6, this device has a pair of side frames 1.

A pair of upper bars 2 and a pair of lower bars 3 extend between upper portions of the side frames 1 and between lower portions thereof, respectively, with spaces therebetween in the corrugated sheet feed direction.

An upper stationary frame 4 and a lower stationary frame 5 are mounted on the pair of upper bars 2 and on the pair of lower bars 3, respectively, at their longitudinal central portions, with the upper stationary frame 4 disposed right over the lower stationary frame 5.

Four upper movable frames 6 are provided, two each between the upper stationary frame 4 and each side frame 1. Four lower movable frames 7 are provided, each under and opposite to one of the upper movable frames 6.

The four upper movable frames 6 are movable along linear rails 8 fixed to the bottoms of the upper bars 2. Similarly, the four lower movable frames 7 are movable along linear rails 9 fixed to the tops of the lower bars 3.

An upper feed screw mechanism 10 comprises four threaded shafts 11 and four nut members 12 each fixed to one of the upper movable frames 6. Each threaded shaft 11 is in threaded engagement with the nut member 12 of one of the four upper movable frames 6 and loosely extends through the other three upper movable frames 6. With this arrangement, the four upper movable frames 6 are individually positionable by means of the upper feed screw mechanism 10 with respect to the upper stationary frame 4.

FIG. 2 shows only two threaded shafts 11 and two nut members 12 for positioning the right-hand ones of the two pairs of upper movable frames 6 on the right- and left-hand sides of the upper stationary frame 4, respectively. But the left-hand one of the two respective pairs of upper movable frames 6 are also positionable the other two of the four threaded shafts 11, shown in FIG. 6, and the nut members 12 that are in threaded engagement with the other two threaded shafts 11.

Each threaded shaft 11 extends loosely through holes 13 formed in the upper stationary frame 4 and the three upper movable frames 6 other than the one to be positioned by this threaded shaft.

A lower feed screw mechanism 14 comprises four threaded shafts 15 and four nut members 16 each fixed to one of the lower movable frames 7. Each threaded shaft 15 is in threaded engagement with the nut member 16 of one of the four lower movable frames 7 and loosely extends through the other three lower movable frames 7. With this arrangement, the four lower movable frames 7 are individually positionable by means of the lower feed screw mechanism 14 with respect to the lower stationary frame 5.

Each threaded shaft 15 extends loosely through holes 17 formed in the lower stationary frame 5 and the three lower movable frames 7 other than the one to be positioned by this threaded shaft.

As shown in FIGS. 1 to 3, the threaded shaft 11 and the threaded shaft 15 for positioning each upper movable frame 6 and the corresponding lower movable frame 7, respectively, are rotated synchronously with each other by means of a synchronizing mechanism 20. Thus, when one of the above two threaded shafts is driven, the corresponding pair of upper and lower frames 6 and 7 are moved in the same direction by the same distance.

Each synchronizing mechanism 20 comprises a transmission shaft 21 extending between one end of one of a pair of threaded shafts 11 and 15 and the corresponding end of the other of the pair of threaded shafts 11 and 15, a pair of universal joints 22 and 23 connected to the top and bottom ends of the transmission shaft 21, respectively, a pair of bevel gears 24 provided between the upper universal joint 22 and the end of the upper threaded shaft 11, and a pair of bevel gears 25 provided between the lower universal joint 23 and the end of the lower threaded shaft 15. The lower threaded shaft 15 is rotated by a driving unit (not shown) and its rotation is transmitted to the transmission shaft 21 through the pair of bevel gears 25 and the rotation of the transmission shaft 21 is transmitted to the upper threaded shaft 11 through the pair of bevel gears 24.

The synchronizing mechanisms 20 are not limited to the type as described. For example, chain transmission mechanism may be used which each comprise sprockets mounted on ends of a pair of upper and lower threaded shafts 11 and 15, and a chain trained about the sprockets.

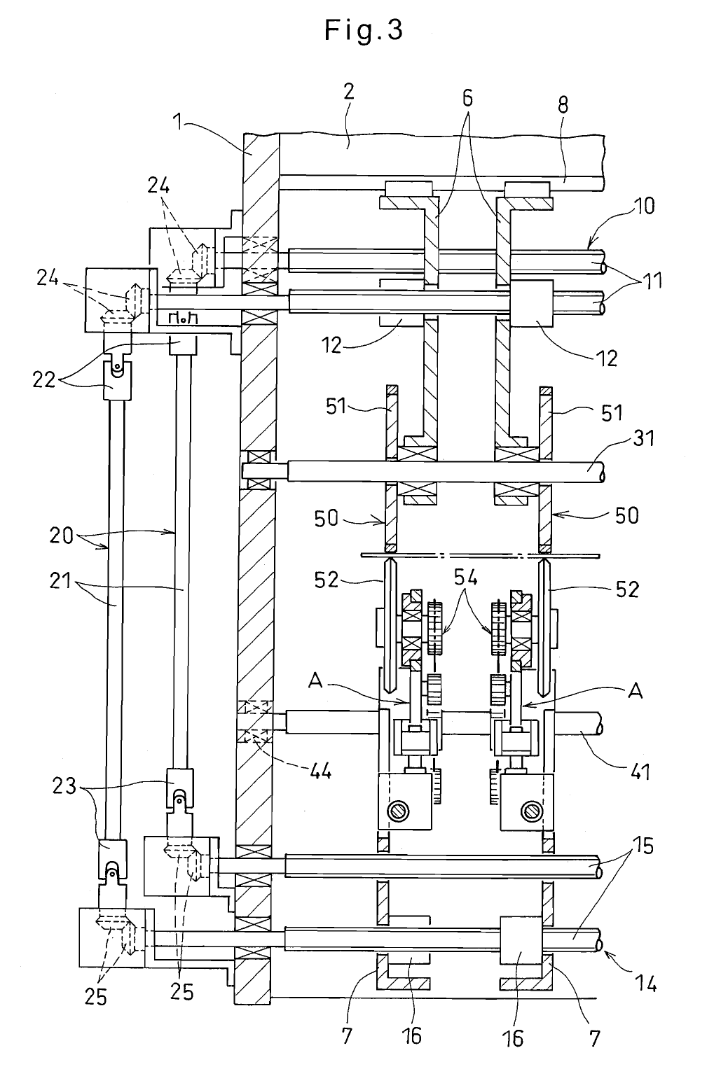

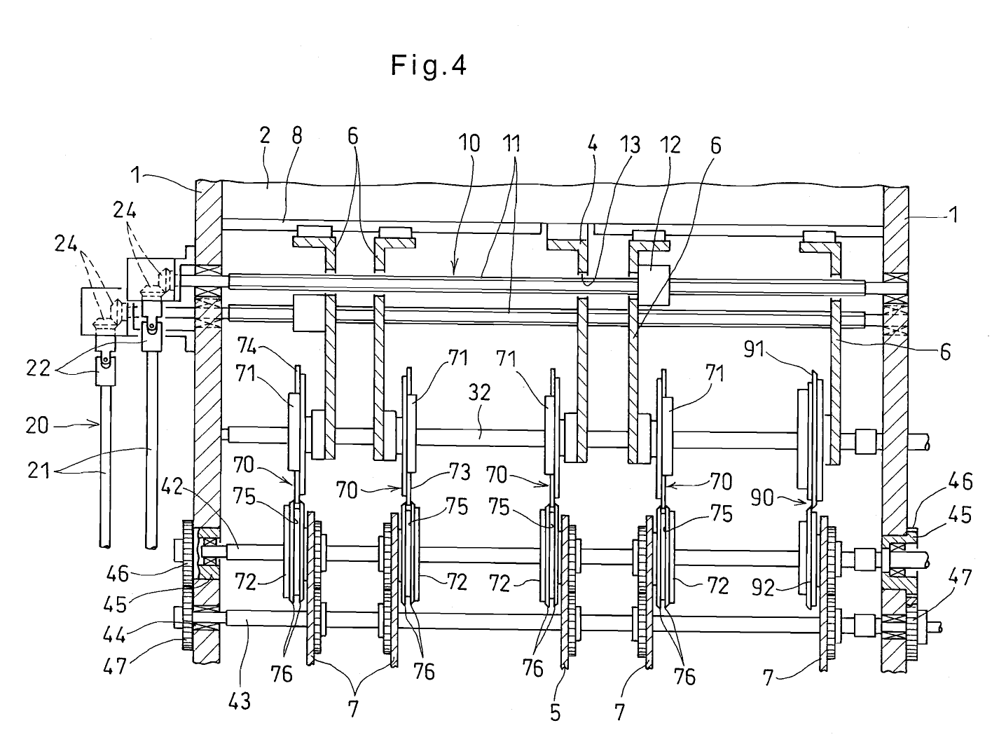

As shown in FIG. 6, above the feed path of corrugated sheets S₀, a first rotary shaft 31 is provided, and a second rotary shaft 32 is provided downstream of the first rotary shaft 31. As shown in FIGS. 3 and 4, the first rotary shaft 31 and the second rotary shaft 32 extend through the four upper movable frames 6 and the upper stationary frame 4 and have their both ends rotatably supported by the pair of side frames 1. They are rotated by a driving unit (not shown) in the direction of arrows in FIG. 6. The first rotary shaft 31 and the second rotary shaft 32 are spline shafts and movably support the four upper movable frames 6.

As shown in FIG. 6, below the feed path of corrugated sheets S₀, a first drive shaft 41 is provided, and a second drive shaft 42 is provided downstream of the first drive shaft 41. Further, an adjusting shaft 43 is provided under the second drive shaft 42.

As shown in FIGS. 2, 3 and 4, the first drive shaft 41 and the second drive shaft 42 and the adjusting shaft 43 extend through the four lower movable frames 7 and the lower stationary frame 5. The first drive shaft 41 and the adjusting shaft 43 have their both ends rotatably supported by bearings 44 mounted on the pair of side frames 1.

The second drive shaft 42 has its both ends rotatably supported by eccentric bearings 45 rotatably supported on the pair of side frames 1.

The first drive shaft 41, the second drive shaft 42 and the adjusting shaft 43 are spline shafts and movably support the four lower movable frames 7. The first drive shaft 41 and the second drive shaft 42 are rotated by a driving unit (not shown) in the direction of arrows in FIG. 6.

As shown in FIG. 4, the eccentric bearings 45 supporting the second drive shaft 42 each include a gear 46 provided on its outer periphery at its outer end which meshes with a drive gear 47 mounted on the corresponding end of the adjusting shaft 43. Thus, when the adjusting shaft 43 rotates, the eccentric bearings 45 rotate, so that the second drive shaft 42 rotates eccentrically about the axis of the outer periphery of the eccentric bearings 45. Thus, by rotating the adjusting shaft 43, the second drive shaft 42 moves up and down, so that the distance between the axis of the second rotary shaft 32 and the axis of the second drive shaft 42 can be adjusted.

As shown in FIGS. 2 and 6, between the upper movable frame 6 and the lower movable frame 7, a creasing unit 50 for forming creases in corrugated sheets S₀ is provided. Downstream of the creasing unit 50, a slotting unit 70 is provided.

Between three (except the one at one end) of the four upper movable frames 6, which are arranged perpendicularly to the sheet feeding direction, and the corresponding lower movable frames 7, creasing units 50 of the same structure as the above-described creasing unit 50 are provided, and downstream of the creasing units 50, slotting units 70 of the same structure as the one described above are provided.

On the other hand, between the upper movable frame 6 at one end and the corresponding lower movable frame 7, a press unit 80 for pressing one side edge of corrugated sheets S₀ is provided. A cutting unit 90 shown in FIG. 4 is provided downstream of the press unit 80.

As shown in FIGS. 6 to 8, the creasing units 50 each comprise a female creasing roll 51 as a receiving roll mounted on the first rotary shaft 31, a male creasing roll 52 provided under the female creasing roll 51, a positioning means A for positioning the male creasing roll 52 relative to the female creasing roll 51, and a rotation transmission means 54 for transmitting the rotation of the first drive shaft 41 to the male creasing roll 52.

The female creasing roll 51 is rotationally fixed to the first rotary shaft 31 and is rotatably supported on one of the upper stationary frame 4 and the upper movable frames 6. When positioning any of the above three upper movable frames 6, the female creasing roll 51 mounted on this upper movable frame 6 moves together with the upper movable frame 6 in the axial direction of the first rotary shaft 31.

The male creasing roll 52 has on its outer periphery a rib 52a for forming creases. The positioning means A, which adjusts the distance between the male creasing roll 52 and the female creasing roll 51 by moving the male creasing roll 52, comprises a roller arm 53 pivotable about the first drive shaft 41 and rotatably supporting the male creasing roll 52, and a pivoting means 55 for pivoting the roller arm 53. The roller arm 53 is supported by the corresponding one of the lower stationary frame 5 and the lower movable frames 7. When adjusting any of the above three lower movable frames 7, the roller arm 53 mounted on this lower movable frame 7 moves together with the lower movable frame 7 in the axial direction of the first drive shaft 41.

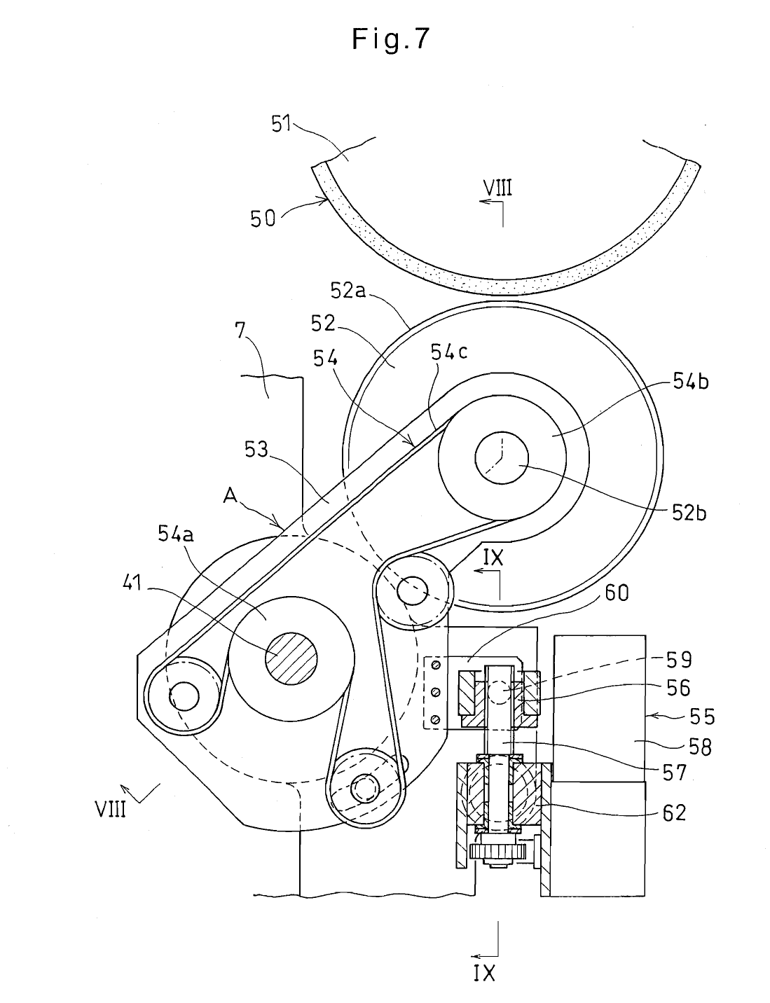

As shown in FIGS. 7, 9 and 10, the pivoting means 55 comprises a nut member 56, a threaded shaft 57 in threaded engagement with the nut member 56, and a motor 58 for rotating the threaded shaft 57. The nut member 56 has diametrically opposed pins 59 on its outer periphery. The pins 59 are rotatably supported by a nut holder 60 fixed to the roller arm 53.

The threaded shaft 57 is rotatably supported by a bearing member 62 coupled to the corresponding one of the lower stationary frame 5 and the lower movable frames 7, and the motor 58, too, is supported by the bearing member 62. Thus, when the threaded shaft 57 is rotated by driving the motor 58, the nut member 56 moves along the threaded shaft 57 and the roller arm 53 pivots up or down about the first drive shaft 41. Because the male creasing roll 52 is supported by the roller arm 53, the male creasing roll 52 moves toward or away from the female creasing roll 51 by pivoting the roller arm 53, so that the clearance between the male creasing roll 52 and the female creasing roll 51 can be adjusted.

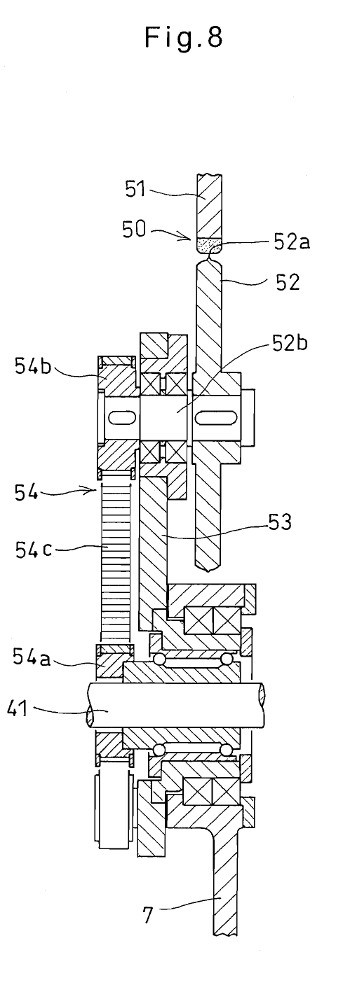

As shown in FIGS. 7 and 8, the rotation transmission means 54 comprises a driving toothed pulley 54a rotationally fixed but axially movable relative to the first drive shaft 41, a driven toothed pulley 54b fixedly mounted on a roll shaft 52b of the male creasing roll 52, and a timing belt 54c trained about the toothed pulleys 54a and 54b. The driving toothed pulley 54a is rotatably supported on the roller arm 53.

As shown in FIGS. 4 and 6, the slotting units 70 each comprise an upper rotary cutter 71 rotationally fixed to the second rotary shaft 32, and a lower rotary cutter 72 as a receiving cutter rotationally fixed to the second drive shaft 42. The upper rotary cutter 71 is rotatably supported by the corresponding one of the upper stationary frame 4 and the upper movable frames 6 and has two circumferentially spaced slot blades 73 and 74. The slot blade 74 is circumferentially positionable relative to the other slot blade 73.

The lower rotary receiving cutter 72 is formed with an annular groove 75 for receiving the slot blades 73 and 74 of the upper rotary cutter 71. The opening edges of the annular groove 75 serve as cutting edges 76.

As shown in FIG. 2, the press unit 80 comprises an upper press roll 81 rotationally fixed to the first rotary shaft 31, a lower press roll 82 provided under the upper press roll 81, a roller arm 53 pivotable about the first drive shaft 41 and rotatably supporting the lower press roll 82, a rotation transmission means 54 for transmitting the rotation of the first drive shaft 41 to the lower press roll 82, and a pivoting means 55 for pivoting the roller arm 53 about the first drive shaft 41.

Since the rotation transmission means 54 and the pivoting means 55 of the press unit 80 have the same structure as those of the creasing units 50, their description is omitted and the same numerals are used for the same parts.

The upper press roll 81 is rotatably supported on the corresponding upper movable frame 6, and moves together with the upper movable frame 6 axially of the first rotary shaft 31 when positioning the upper movable frame 6.

As shown in FIG. 4, a slitting unit 90 comprises an upper slitter blade 91 rotationally fixed to the second rotary shaft 32, and a lower slitter blade 92 rotationally fixed to the second drive shaft 42. The upper slitter blade 91 is rotatably supported on the corresponding upper movable frame 6, and moves together with the upper movable frame 6 axially of the second rotary shaft 32 when positioning the upper movable frame 6. The lower slitter blade 92 is rotatably supported on the corresponding lower movable frame 7, and moves together with the lower movable frame 7 axially of the second drive shaft 42 when positioning the lower movable frame 7. The lower slitter blade 92 rotates in contact with the side face of the upper slitter blade 91 to cut one side edge of the corrugated sheet S₀ being fed, in cooperation with the upper slitter blade 91.

The creasing/slotting device embodying this invention has the above-described structure. When the first rotary shaft 31 and the first drive shaft 41 rotate, the female creasing rolls 51 and the male creasing rolls 52 of the plurality of creasing units 50 rotate in opposite directions as shown by arrows in FIG. 6, and the upper press roll 81 and the lower press roll 82 of the press unit 80, too, rotate in opposite directions.

Also, when the second rotary shaft 32 and the second drive shaft 42 rotate, the upper rotary cutters 71 and the lower rotary receiving cutters 72 of the plurality of slotting units 70 rotate in opposite directions as shown by arrows in FIG. 6, and the upper slitter blade 91 and the lower slitter blade 92, too, rotate in opposite directions.

While the first rotary shaft 31, the second rotary shaft 32, the first drive shaft 41 and the second drive shaft 42 are rotating, the corrugated sheet S₀ shown in FIG. 11(I) is fed. When the sheet S₀ passes between the female creasing rolls 51 and the male creasing rolls 52 of the creasing units 50, the ribs 52a provided on the outer periphery of the male creasing rolls 52 press the sheet S₀, so that four longitudinal creases b₁ to b₄ are formed in the sheet S₀ as shown in FIG. 11(II). Also, the upper and lower press rolls 81 and 82 of the press unit 80 press one side edge of the corrugated sheet S₀. At e of FIG. 11(II), the pressed portion of the corrugating medium formed by pressing is shown.

After forming the creases, when the corrugated sheet S₀ is fed downstream and passes between the upper rotary cutters 71 and the lower rotary receiving cutters 72 of the plurality of slotting units 70, as shown in FIG. 11(II), slots c are formed in the front and rear portions of the corrugated sheet S₀ with respect to the sheet feed direction, i.e. at both ends of the longitudinal creases b₁ to b₃ by the pairs of slot blades 73 and 74 mounted on the respective upper rotary cutters 71. Also, one side edge of the pressed portion e of the sheet S₀ is cut off by the upper slitter blade 91 and the lower slitter blade 92 to remove the unnecessary portion.

By providing corner cutting edges on the side faces of the pair of slot blades 73 and 74 of the upper rotary cutter 71 supported on the left-hand upper movable frame 6 among the four upper movable frames 6 shown in FIG. 4 and providing the corresponding lower rotary receiving cutter 72 with receiving portions for receiving the corner cutting blades, corners along the other side edge of the corrugated sheet S₀ can be cut off by the corner cutting blades to form a bonding portion d, thus providing the blank S₁ shown in FIG. 11(II).

When in the next folding station, the blank S₁ is formed into a flat box by folding and bonding the panels P₁ and P₄, since the pressed portion e is bonded to the bonding portion d, its thickness at its central portion of the sheet width where the bonding portion d is located is substantially the same as the thickness at any other portion of the sheet.

In forming other blanks S₁ in which the distances between the longitudinal creases b₁ to b₃ and the distances between the slots c are changed, the movable frames 6 are moved relative to the upper stationary frame 4 and the lower movable frames 7 are moved relative to the lower stationary frame 5 to reposition the respective creasing units 50 and slotting units 70.

The creasing units 50 and the slotting units 70 are positionable by rotating the threaded shafts 15 of the respective lower feed screw mechanisms 14.

When the threaded shaft 15 of any of the lower feed screw mechanisms 14 is rotated, its rotation is transmitted through the synchronizing mechanism 20 to the threaded shaft 11 of the corresponding upper feed screw mechanism 10, so that the corresponding upper and lower movable frame 6 and 7 move simultaneously axially of the threaded shaft 11 by the same distance in the same direction.

Since on the upper movable frames 6 and the lower movable frames 7 forming pairs, the female and male creasing rolls 51, 52 forming the creasing units 50 and the upper and lower rotary cutters 71, 72 forming the slotting units 70 are supported, when the creasing units 50 and the slotting units 70 are positioned, the relative position between each creasing unit 50 and the corresponding slotting unit 70 remains unchanged.

Therefore, after such positioning, slots c can be formed at both ends of the respective longitudinal creases b₁ to b₃ with the central axes of the slots c aligned with the respective longitudinal creases b₁ to b₃.

Therefore, by forming a flat box from the blank S₁, erecting it into a three-dimensional rectangular tube, and folding the lid flaps F₁ to F₄ and bottom flaps F₅ to F₈ inward by 90 degrees into a box shape, a good packaging box can be formed which is free of misalignment between the opposed pair of lid flaps F₁ and F₃ and between the opposed pair of bottom flaps F₅ and F₈.

Also, although in the embodiment, the four upper movable frames 6 are positionable with respect to the upper stationary frame 4 and the four lower movable frames 7 are positionable with respect to the lower stationary frame 5, the upper stationary frame 4 and the lower stationary frame 5, too, may be positionable.

Also, although in the embodiment, the male creasing rolls 52 are provided under the female creasing rolls 51 and the rotary receiving cutters 72 formed with the annular recess 75 are provided under the rotary cutters 71 having the slot blades 73, 74, this arrangement may be reversed.

Further, although in the embodiment, the slots c are formed at both ends of each the longitudinal creases b₁ to b₃, some packaging box has no lid flaps F₁ to F₄ or no bottom flaps F₅ to F₈. When a blank for forming such a packaging box is formed, one of the pair of slot blades 73, 74 on each upper rotary cutter 71 should be removed to form a slot c at only one end of each of the longitudinal creases b1 to b3.

1. A creasing/slotting device comprising a plurality of vertically opposed pairs of upper and lower movable frames arranged perpendicularly to a sheet feed direction, upper feed screw mechanisms each having a threaded shaft and capable of individually positioning the upper movable frames in a direction perpendicular to the sheet feed direction by turning the threaded shafts of the respective upper feed screw mechanisms, lower feed screw mechanisms each having a threaded shaft and capable of individually positioning the lower movable frames in a direction perpendicular to the sheet feed direction by turning the threaded shafts of the respective lower feed screw mechanisms, synchronizing mechanisms each provided between the two threaded shafts of the pair of upper and lower feed screw mechanisms for positioning one of said plurality of vertically opposed pairs of upper and lower movable frames, respectively, for synchronizing the rotations of the two threaded shafts, a plurality pairs of male creasing rolls and receiving rolls for forming creases in a sheet, one and the other of each pair of said male creasing rolls and receiving rolls being supported on one and the other of a vertically opposed pair of said upper and lower movable frames, respectively, and a plurality pairs of rotary cutters for forming slots at ends of creases formed in the sheet, one and the other of each pair of said rotary cutters being supported on one and the other of a vertically opposed pair of said upper and lower movable frames, respectively.
